(19) United States
(12) Patent Application Publication
(10) Pub. No.: US 2015/0104024 A1
(43) Pub. Date: Apr. 16, 2015

(54) SYSTEM AND METHOD FOR MONITORING NOISE LEVEL

(71) Applicant: Robert Lindsay RUSSELL, Tauranga (NZ)

(72) Inventor: Robert Lindsay RUSSELL, Tauranga (NZ)

(21) Appl. No.: 14/515,898

(22) Filed: Oct. 16, 2014

(30) Foreign Application Priority Data
Oct. 16, 2013 (NZ) 631475

(51) Int. Cl. H04R 29/00

(52) U.S. Cl. CPC H04R 29/00
USPC 381/56

(57) ABSTRACT

Disclosed is an apparatus for monitoring and/or recording noise levels at a location under surveillance over a time period. The apparatus includes a unit for capturing visual data of the location under surveillance, a unit for capturing audio data at the location under surveillance, a noise level process for deriving noise level data at the location under surveillance, and a unit to couple the visual and audio data with the noise level data.

### TECHNICAL FIELD OF THE INVENTION

The present invention relates to systems and methods for monitoring and/or recording noise level data in combination with coupled visual and/or other situational awareness data in the context of events at a location.

In particular, though not solely, the present invention is directed to evidentiary recording of coupled real time law enforcement grade noise level data and video type visual and audio data in the context of events at a location, so that a person viewing the video recording at a later time has an accurate visual display of the noise level in the context of other events that may be occurring at the location—i.e. so that the viewer has situational awareness.

### BACKGROUND OF THE INVENTION

Sound or noise (including noise due to vibrations) exceeding a certain level can affect the comfort and health of the people around the source of noise. Excessive noise due to music systems, concerts, construction work, machinery, transport infrastructure and so on is normally annoying for the people in close vicinity to the sound source.

There are generally laws and good planning practices for controlling, regulating and monitoring noise levels. These laws and good practice techniques usually eventually require that vibration/sound levels be measured, either for purposes of resolving conflict or for audit or town planning purposes. For example, neighbours may become annoyed or affected by noise or potential noise levels that they believe come from an existing facility or that may potentially come from a proposed nearby facility. They may complain to the local council or the local town planning authority. A person, particularly a warranted noise control officer or a privately employed acoustic consultant, may go to the complaint site or proposed site and attempt to gather good quality, detailed transparent and neutral situational evidence for presentation in a disputes resolution meeting, or potentially for presentation to a decision maker, enforcement court or town planning entity.

Alternatively, parties may wish to document an existing situation before a new development is started.

A number of devices exist in the prior art, for example measurement of sound levels using sound level meters and measurement of vibration levels using vibration meters. These generally require a person to be trained to an expert level in using the device and trained in separately recording all of the situational data to appropriate evidential standards. Such a person may use a video camera in supporting evidence. Typically, currently used camera capture only limited degree field of vision information. It may also require expert user's extensive specialised training to capture sufficient information, and even this may be inadequate. This level of expertise and presence of mind is not easily available, particularly at short notice, for example in the middle of the night,

Thus the prior art has a number of disadvantages. The foremost is that it requires a highly trained person to be physically present at short notice or at unsocial hours to make the recording. It does not provide replayable situational awareness, which is important in any evidentiary recording for purposes of any dispute or enforcement proceeding.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved noise level monitoring system or to overcome the above shortcomings or address the above desiderata, or to at least provide the public with a useful choice.

### BRIEF DESCRIPTION OF THE INVENTION

In a first aspect the present invention may be said to broadly consist in an apparatus for monitoring and/or recording noise levels at a location under surveillance over a time period, comprising:
means for capturing visual data of the location under surveillance;
means for capturing audio data at the location under surveillance;
noise level processing means for deriving noise level data at the location under surveillance; and
means to couple the visual and audio data with the noise level data.

Preferably the data is also coupled with further data comprising one or more of: location data; meteorological data; vehicle movement data.

Preferably the apparatus further comprises one or more means for time stamping the data and synchronising the time stamps.

Preferably the data is provided in a format whereby it may be presented on an audio visual display device with the noise level data portrayed on the display device.

Preferably one or more visuals of the location along with the audio data are presented simultaneously on the display device with the noise level data portrayed on the display device.

Preferably the further data is also portrayed on the display device.

Preferably the data is provided in a video format whereby it may be presented on the display device wherein one or more visual data and the noise level data are displayed simultaneously with the audio data being played as sound.

Preferably the data is processed to provide a file in a multi-feed type video format to be portrayed on a multi-feed viewer presenting visual data, noise level data as one or more feeds.

Preferably the further data is also presented as one or more feeds.

Preferably the apparatus comprises one or more means for recording the data for a later playback.

Preferably the apparatus comprises one or more means for distributing said visual file.

Preferably said noise level processing means comprises a sound level meter for deriving sound level data and/or a vibration meter for deriving vibration level data.

Preferably the noise level data includes sound level and/or vibration level data.

Preferably the noise level data is portrayed as a level versus time plot and/or numerically.

Preferably the system is provided on a portable or mobile apparatus.

Preferably the mobile apparatus comprises one or more of: vehicle, trolley type device, handheld device.

In another aspect the invention broadly consists in a portable apparatus containing or including a noise level data collection and/or processing system, comprising:
means for capturing audio visual data of a location under surveillance; and
means for deriving noise level data at the location under surveillance.

Preferably the portable apparatus comprises means to couple the visual and audio data with the noise level data.

Preferably the portable apparatus comprises a housing containing the noise level data collection and/or processing system.

Preferably the portable apparatus comprises a vehicle containing or including the noise level data collection and/or processing system.

In a further aspect the invention broadly consists in a method of monitoring and/or recording data relating to noise levels at a location under surveillance, the method including:
capturing audio visual data of the location under surveillance;
measuring noise level data at the location under surveillance; and
processing or otherwise coupling the audio visual data with the noise level data so that the audio visual data can be portrayed at a later time together with the measured noise level data, wherein the audio visual data and the noise level data are synchronised.

Preferably the method includes processing the data to provide a file in a video format which may be played by an audio visual display device with the noise level data portrayed on the display device.

Preferably the method comprises coupling or processing the data with further data comprising one or more of: location data; weather data; vehicle movement data.

Preferably the method includes processing the data to provide a file in a video type data format which may be played by an audio visual display device with the noise level data and the further data portrayed on the display device.

Preferably the method includes processing the data to provide a file in a video format which may be played by a multi-feed viewer portraying synchronised audio visual data, noise level data, and further data as one or more feeds.

Preferably the method includes measuring the sound level data and/or vibration level data as an indication of noise level data

Preferably the method includes processing data so that the noise level data and the further data is either portrayed numerically or as a level versus time plot.

Preferably the file may be used for making a determination whether the noise levels are above an acceptable level.

Preferably the method comprises continuously monitoring the location under surveillance.

Preferably said visual file is used for one or more of: evidential purposes, dispute resolution, law enforcement purposes, town planning purposes, environmental mediation, audit purposes.

Preferably said visual files provide situational awareness which enables one or more decision makers in determining noise violation.

In yet another aspect the present invention may be said to broadly consist in a noise monitoring system as described herein with reference to any one or more of the accompanying drawings.

In yet a further aspect the present invention may be said to broadly consist in a method of determining noise level violation at a location under surveillance as herein described when serviced as herein described.

The invention may be used to electronically document existing environmental situations when a new development is proposed for the existing environment.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 Shows a noise monitoring system of the present invention;

FIG. 2 Shows a method of obtaining noise level information;

FIG. 3 Shows a portable noise monitoring apparatus;

FIG. 4 Shows the portable noise monitoring apparatus of FIG. 3 mounted on a vehicle;

FIG. 5 Shows a video screen snapshot of a single camera portrayed with sound level data, location data, weather data and date-time stamp;

FIG. 6 Shows a video screen snapshot of three video cameras capturing 360° coverage and is portrayed with sound level data, location data, weather data and date-time stamp;

FIG. 7 Shows a video screen shot of multi-feed viewer depicting coverage by three video cameras, and noise level data simultaneously;

FIG. 8a-8c Shows screen snapshots of three video cameras capturing 360° view of the site; and

FIG. 8d Shows a snapshot of real time sound level versus time plot.

### DETAILED DESCRIPTION OF THE INVENTION

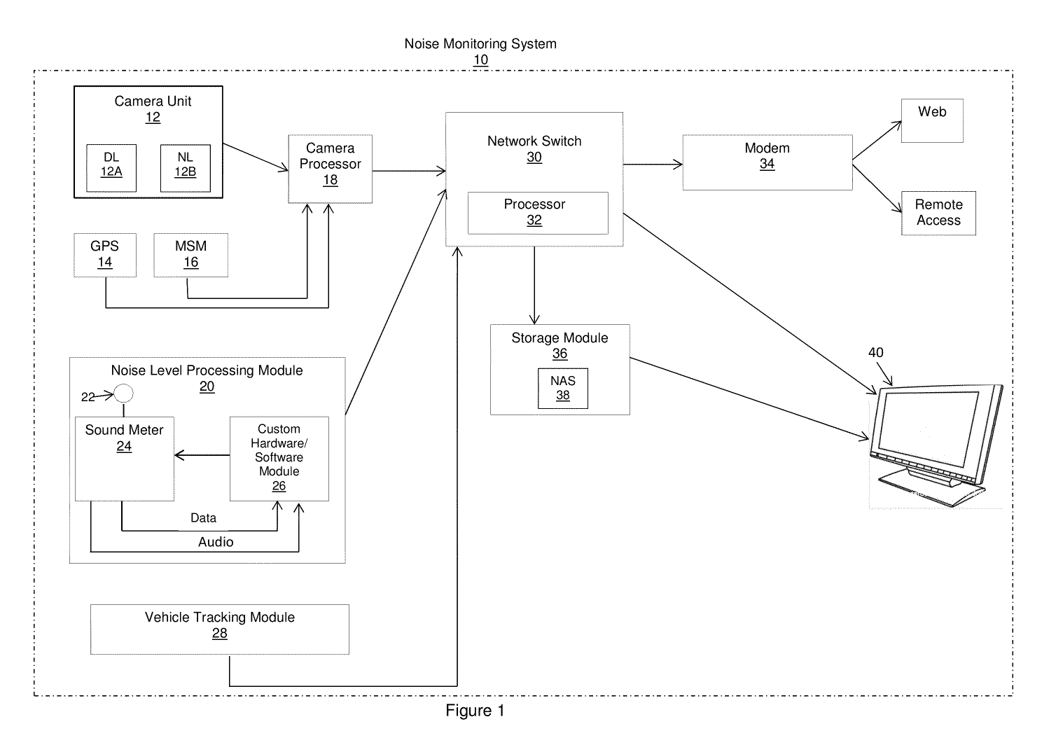

Some exemplary embodiments of the invention will now be described with reference to FIGS. 1 through 8.

FIG. 1 shows a noise monitoring system 10 of the present invention.

In one implementation the noise monitoring system 10 can be mounted on a mobile device, like a vehicle, or a trolley type device, outside the place where noise levels are to be monitored, like outside a house, a building, concert venue and so on. In another implementation, the monitoring system 10 can be mounted on a suitable mount, such as a wall, post or fence, or any other suitable place close to the surveillance location. In yet another implementation, the monitoring system 10 can be a hand held system.

The monitoring system 10 comprises a camera unit 12, a Global Positioning System (GPS) device 14, a meteorological station module (MSM) 16, a Noise Level Processing (NLP) Module 20, a Vehicle Tracking Module (VTM) 28, a camera processor 18, a network switch 30, a storage module 36, a modem 34, and a display 40. The functionalities of each of the parts are described below.

The camera unit 12 is preferably a security grade camera capable of capturing high definition images or videos. This camera unit 12 can also ideally capture wide angle views or 360° view of the location or site under surveillance. The camera unit 12 may also consist of a Day Lens (DL) 12A and a Night Lens (NL) 12B. With the capability of day and night lens 12A and 12B respectively the camera unit 12 is capable capturing high definition videos even during the night. The captured image or video may also have a time and date stamp on it. One or more camera units 12 may be installed to capture different views of the site under surveillance. The output of the camera unit 12 is transferred to the camera processor 18.

The GPS device 14 of the monitoring system 10 obtains the exact location information of the object on which the noise level monitoring system 10 is mounted. The GPS device 14 works in a known usual manner by communicating with the satellites to get exact location coordinates, such as longitude and latitude information, of the device or mount it is installed on. So in case the noise level monitoring system 10 is installed on a vehicle the GPS device 14 will give the exact location of the vehicle. The information from the GPS device 14 is transferred to the camera processor 18.

Further, the MSM 16 is in continuous/periodic communication with the meteorological station to fetch the weather information, like rainfall, humidity, wind speed and temperature. The captured information from MSM 16 is also transmitted to the camera processor 18.

The camera processor 18 upon receiving image/video from camera unit 12, location data from GPS device 14, and the weather data from meteorological station module 16 processes the data to create security camera grade digitally signed visual file(s). This visual file can be in the form of an image (or series of images) or a video of the area under surveillance. The visual file includes superimposed, time and date stamp, location information and weather information positioned at one corner of the visual file or any other appropriate place.

The Noise Level Processing Module 20 consists of a microphone 22, a sound meter 24 custom hardware/software module 26. In one implementation, the microphone 22 may be replaced by an accelerometer to measure vibration data. In another implementation, the microphone 22 and accelerometer may be provided together to measure both sound and vibrations. So wherever the term microphone is used throughout the specification, it means microphone and/or accelerometer capturing noise data which is in the form of sound and/or vibration.

In an embodiment, the microphone 22 may be part of the camera unit 12. In another embodiment, the microphone 22 may be a separate module or a unit. Irrespective of where the microphone 22 is positioned, the purpose of the microphone 22 is to record audio having the highest possible clarity and capable of removing interferences and noise

The output of the microphone 22 (and/or accelerometer) is coupled to the sound meter 24 which is capable of creating audio files based on the recordings received from microphone 22. The audio file represents the actual sound that was being made at the site under surveillance. This helps the concerned professional to be aware of the situational awareness by hearing the actual noise. For example, excessive sound from a particular vehicle passing nearby or a dog barking in the neighbourhood should not be misunderstood as a sound coming from the location being monitored.

The audio data and other information about the recording processed by the sound meter is transmitted from the sound meter 24 to the custom hardware/software module 26. The custom hardware and/or software module 26 is configured to create noise level data files. The noise level data gives an exact indication of the noise levels for the monitored period. Noise level data files help the concerned people to determine the exact sound and/or vibration level value at a location under surveillance.

In one implementation, the noise level data provides numerical values of the sound and/or vibration level, like in decibels or any other value representing sound. The numerical values are continuously updated for the monitoring period. This helps to determine whether the noise level was above or below the reference numerical value. In another implementation, the noise level value is portrayed as a sound and/or vibration level versus time continuously updating plot. This gives an indication, that for a particular monitoring period, of the time instances when the noise level went above the acceptable level. More specifically, the noise level data files help to provide an indication whether the noise level is above or below the required sound and/or vibration level.

Excessive vibration due to a railway line passing nearby or a mining blasts or transport or even due to loud music may be sometimes annoying the residents in the neighbourhood. The vibrations may be measured by an appropriate transducer, such as an accelerometer. The data from the accelerometer is also fed to sound meter 24 and the module 26 which provides the vibration level data in the form of changing values or a vibration level versus time plot. The vibration level data may give an indication of the duration and instances when the vibration level went above the acceptable level.

The monitoring system 10 may also capture movement data of vehicle in the close vicinity of the site under surveillance. The vehicle tracking module 28 may capture movements of cars, train, flights, ships and buses around the site. The advantage of capturing information about the vehicle movement is that if a sudden spike is observed in the noise level which may be due to the movement of the train or the bus, the sudden spike should not be misunderstood as noise violation at the site. The corresponding vehicle movement data may further help the decision makers in analysing the situation based on the captured vehicle data in making a decision on noise violation. Information about vehicle movement may be obtained from different sources like radar systems, real time flight, train, ship and bus movement data from the respective departments. The cctv footages can also be obtained if available. The real time vehicle movement data may be displayed in the form of graph or a video of the vehicle movement.

All the modules and the data obtained from different modules are synchronized in time to give an exact representation of the events occurring at the surveillance site.

Since the noise level monitoring system 10 is used for evidential purposes, to determine violation of the sound/vibration level, the data captured from different parts or modules is not altered in any form, except for clarity purposes or removing interferences.

Further, the visual file(s) from the camera processor 18, the audio data, the noise level data from the NLP module 20 and the vehicle movement data from the vehicle tracking module 28 is transferred to the network switch 30 which further makes it available for access by concerned people through different ways (explained below).

The system 10 also has a processor(s) 32 which may be part of the network switch 30 that synchronises the time stamps of the visual data, audio data, noise level data (including sound and/or vibration level data) and vehicle movement data to create an audio visual (AV) file. In one implementation the processor 32 is not part of the network switch and the data from different modules is synchronized to create the AV file by the processor 32 and then transferred to the network switch 30 for further distribution or display.

In one embodiment, a multi-feed AV file is created which includes different feeds, such as one or more feeds visual file(s) of the area under surveillance, the noise level data feed (sound level data and/or the vibration level data), and vehicle movement data feed with the audio of the actual noise being heard at the monitored location in the background. The multi-feed AV file can be displayed on a large display screen 40 which may be a multi-feed viewer, to simultaneously display the above captured data in real time or may be recorded for a playback later to aid the decision makers in determining whether a noise violation occurred or not.

In another embodiment, the camera processor 18 may receive image/video from camera unit 12, location coordinates from GPS device 14, weather information from MSM 16, audio files and noise level values from the noise level processing module 20, processes the data to create security camera grade digitally signed visual file(s). The processor 8 synchronise the visual data time stamps with the time stamps of audio and noise level data. This visual file can be in the form of an image or a video of the area under surveillance. The visual file includes location information, weather information and noise level information, in the form of sound and vibration level plots or continuously updating values, positioned at one corner of the visual file or any other appropriate place with the audio of the actual noise being heard at the location under surveillance in the background. In one implementation, the visual file includes video of the area under surveillance. One or more such videos may be played depicting different views of the surveillance location. In another implementation, the file created by the processor 18 can be series of images depicting the area being monitored with weather, location and noise level data imprinted on it.

The AV file gives an exact indication of the noise level at a particular place and time. The file also help in hearing the actual noises being made in the background, so that there is no confusion from where the excessive noise is coming. The file to be used as evidence and is of the courts standard. The file aids the decision maker in determining whether there was a noise violation or not by knowing that that the noise levels are above or below an acceptable level. Also, it may be used as an evidence in case of arguments between the officials and people responsible for making the noise that whether there was a noise violation or not.

Further the file may also be used for efficient town planning or audit purposes. For example, if a new road or a train line is proposed for construction close to a residential area. The people of the residential area or the builder or the concerned government officials may record or monitor the noise levels using the above system 10 before the construction begins and keep it as a record. A further reading may be taken after the construction. If the noise levels have gone up the people affected can make claims for discomfort caused due to excessive noise. The builder may also use this as evidence that the noise levels have not gone up after construction.

The system 10 may be placed to monitor a site for a specified period, like a week in this example or for few hours when there is concert going on or on call when there is a complaint received.

The vibration data may further help in situations when there is a mining work going on or a train line passing close to the surveillance site. Based on the captured information and in case of violation observed appropriate measures may be taken to control the noise level.

Furthermore, the advantage of using this system is that the system can be used even by the personnel's not trained in using such systems. The person has to simply drive to the location from where the complaint is received or generally as part of regular surveillance. The system 10 can be mounted on a mobile device, like a vehicle or a trolley or at a suitable point, like a building or a boundary wall. The user just needs to initiate the system by generally pressing a power switch and the rest of the steps are performed by the system without requiring any further user intervention. Also the person does not need to be physically present at the location all the time.

The network switch 30 transfers the created AV file to a modem 34. The modem 34 makes the data either available on the web page for real time viewing or stores on a web server for remote access. The intended users can be provided with a link to access the file. For example, a customer centre may receive information from the network switch 30 for real time analysis and in case of violation, appropriate measures may be taken.

The AV files may be played in real time or stored on the storage module 36. The AV or image files can be also stored in hard drives, DVD or any other suitable device. The storage device 36 may also include a network accessible storage device (NAS) 38 for access by different people at different location.

In the preferred embodiment the noise level monitoring system 10 is continuously in operation to document a current situation.

Although the invention is described in relation to the above mentioned data, but it would be appreciated that any other information which provides situational awareness can be included. Further, capturing the location data, weather data and vehicle movement data is not an essential requirement of the invention and system can be implemented even without these data. Sound level data and vibration level data can be captured together or alternatively.

The weather information may also aid in making decisions, for example if there are strong gusts of wind and rain which may normally affect the noise level. Hearing the actual noise and viewing the noise level data and the weather data may also help to determine the impact of the environmental conditions on the noise levels.

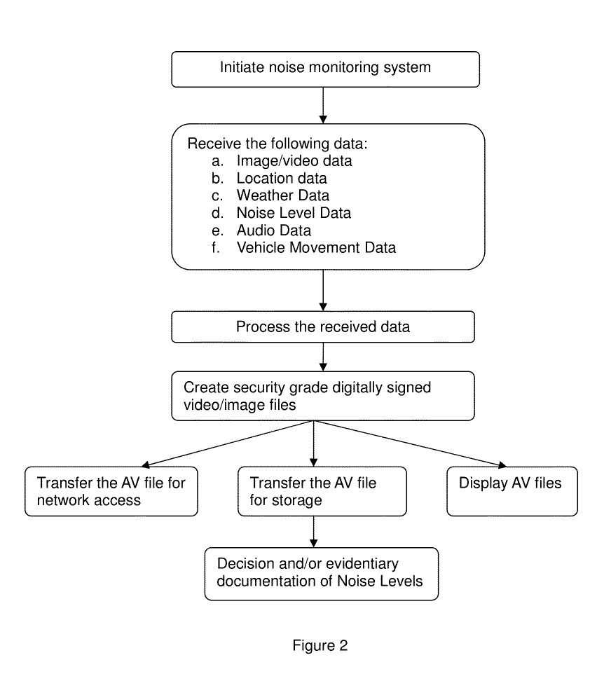

FIG. 2 illustrates a process of monitoring noise levels for determining whether or not the noise levels are above the acceptable value.

The process begins with initiating the noise monitoring system 1. The system 1 can be placed at an appropriate place around the surveillance area, for example in a vehicle outside the boundary of a house, a place close to concert ground positioned on a mount or a building.

After the system 1 has been activated, the video/image data, the location data, the weather information, the noise level data and the vehicle movement data are captured along with the audio recording of the actual noise being heard. As explained hereinabove, the visual data, position data, weather data, noise level data and vehicle tracking data are captured by the camera module 12, the GPS device 14, the meteorological station module 16, noise level processing module 20, and vehicle tracking module 28 respectively.

In one implementation, the camera processor 18 processes the visual data by integrating it with the location data, weather data, the noise level data, and the audio recording to create a security grade digitally signed visual file with the noise information, location coordinates, and weather information embedded. The visual file also has a time & date stamp on it. In one implementation, image file is created with noise level, weather data and location data placed in a box or otherwise at one corner of the image. In another implementation, an AV type file is created capturing displaying one or more videos of the area being monitored including the audio of the actual noise being made in the background. The video file also provides the noise level information (preferably in db), location information and weather information, preferably at one corner of the video, for the entire length of the video.

In another implementation, the captured a multi-feed AV type file created for real time display or for a later playback. The multi-feed AV file includes one or more feeds of the visual data with superimposed, time-date stamp, location and weather data, the noise level data, the vehicle movement data which may be simultaneously displayed, or in selected combinations, on a multi-feed viewer with the actual noise being recreated in the background.

The AV files are high definition files and can be reproduced in different forms, like DVD, CD, hard disk for multiple accesses. These files help in making a determination whether the noise levels are above the acceptable level and also may be used as evidence in case of any arguments or court proceedings or for documentation of current situation.

In one implementation, the created AV file is transferred online via network switch 30 and modem 34 for network access. For example, the files are made available on a website, or a link is provided to access the files based on an authorization.

In another implementation, the files are stored on a storage module and/or a network accessible storage module. The storage module 36 may be directly connected to system 1 or are part of system 1.

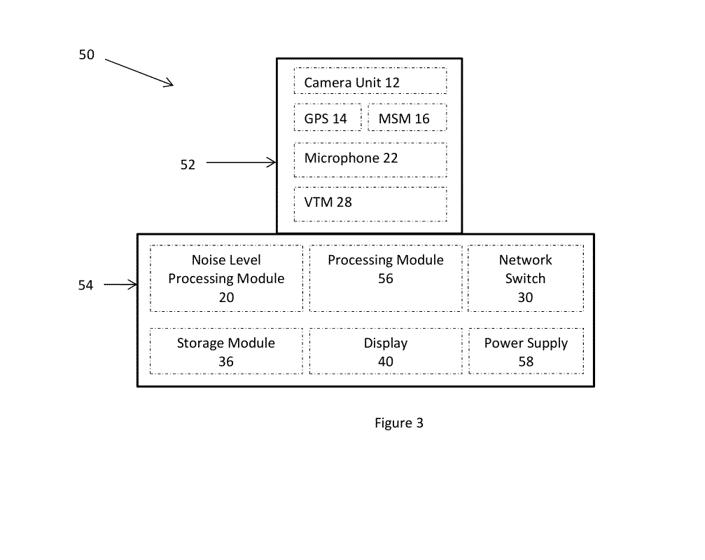

FIG. 3 shows a portable noise monitoring apparatus 50 or a housing that can be attached or mounted on other objects, like on vehicles, on a wall or fence or any other appropriate location. The housing 50 can also be secured at any location outside or close to the surveillance site. The housing 50 may also be locked to protect it from any unappropriated access.

The housing 50 includes one or more attachment means for attaching or locking the housing to other objects. The attachment may include one or more of brackets, straps or other engagement means which secure the housing to other objects.

The housing 50 comprises a data capture module 52 and a data processing module 54. The data capture module 52 is positioned in a manner that it has a clear view of the surveillance site. The data capture module 50 transmits the captured data to the data processing module 52 for further processing. The data capture module 50 and data processing module 52 may be a single unit or two separate units.

The data capture module 52 comprises the camera unit 12 capturing one or more visual data of the location, a gps receiver 14 for receiving location coordinates, and the meteorological station module 16 comprises one or more antenna to receive regular weather updates. The data capture module 52 also has a microphone 22 for capturing the noise data, for example sound and vibration data and a vehicle tracking module 28 for capturing vehicle movement data. The functions of these modules have been discussed earlier.

The information captured by the data capture module 52 is communicated to the data processing module 54 for further processing and determining whether there has been noise violation or for evidentiary recording.

The data processing module 54 comprises the noise level processing module 20 for recording the actual noise that is being heard at the surveillance location and creating noise level data file. As discussed earlier, the noise level data files provides information about the noise levels for the monitoring period, which can be in the form of continuously updating value or time versus level plot.

The data processing module also has a processing module 56 which includes a camera processor 18 and a processor 32 to create audio video data files as discussed earlier. The audio video files can be displayed on the display device 40 or can be transmitted through the network switch for web access. The audio video files can also be recorded and stored in the storage module 36 for access at a later time.

The housing 50 also includes power supply means 58 for connecting the housing to a power outlet or may include batteries or other means for supplying power to the housing.

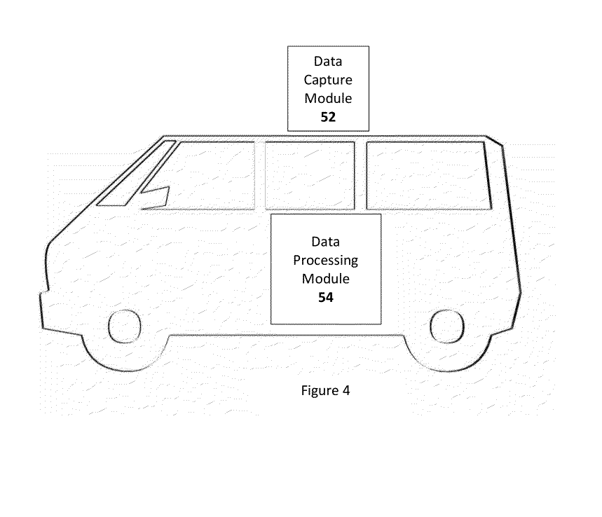

FIG. 4 shows a vehicle including the noise level monitoring system 50 comprising the data capture module 52 and the data processing module 54. The vehicle can be driven to surveillance location and the power supply can be activated. The system 50 starts capturing the noise level data and process the data to determine if there has been any noise level violation or simply be recorded for evidential purposes. The data capture module 52 is mounted above the vehicle so that it has a clear view of the site and the data processing module sits inside the car for processing the captured data. Alternatively the data processing module can also be mounted outside the vehicle.

In an implementation, the housing 50 can be mounted on the vehicle through one or attachment means and can be removed after the data has been processed.

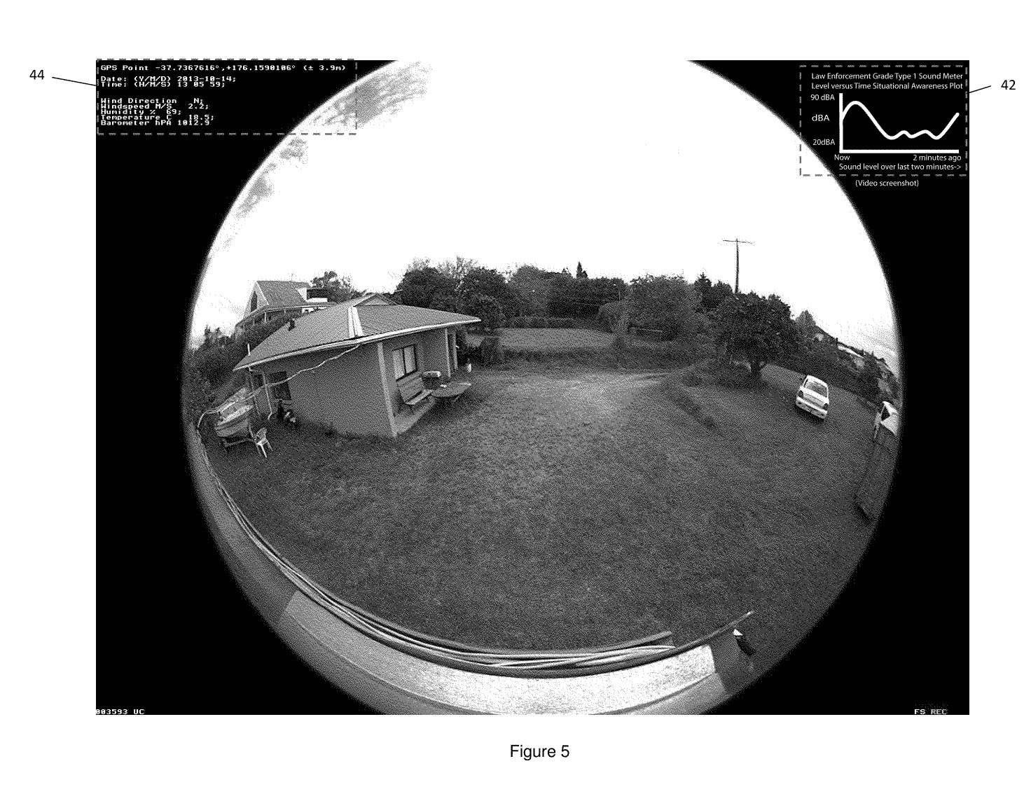

FIG. 5 depicts a screenshot of the camera footage taken by a single wide angle lens of the camera unit 2.

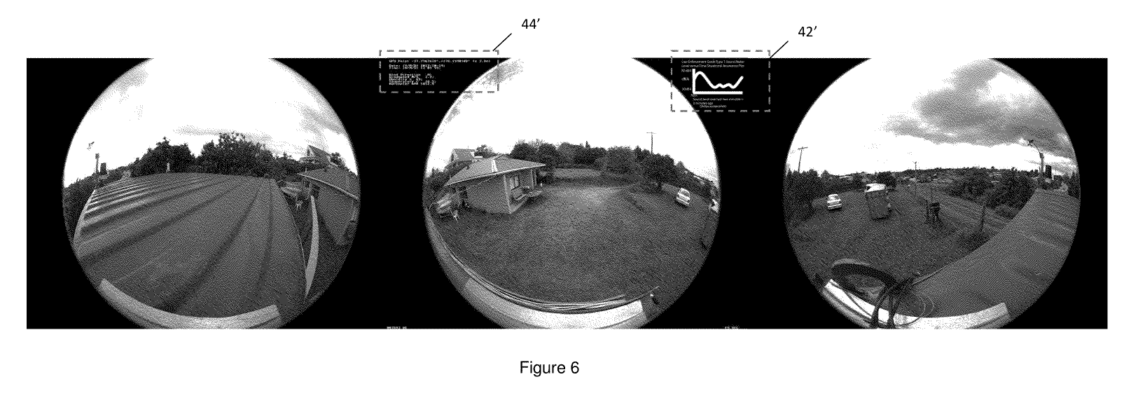

FIG. 6 depicts screenshot of the camera footage taken by three video cameras, capturing 360° view of the location under surveillance.

FIGS. 5 & 6 shows a plot, on the video image, of sound level versus time and is referenced 42 and 42′ in FIGS. 2 & 3 respectively. The video image also displays location information, weather information and date-time stamp, referenced by 44 and 44′ in the figures.

It becomes apparent from FIG. 5 and FIG. 6 that the camera unit is capable of capturing wide angles and HD images and video.

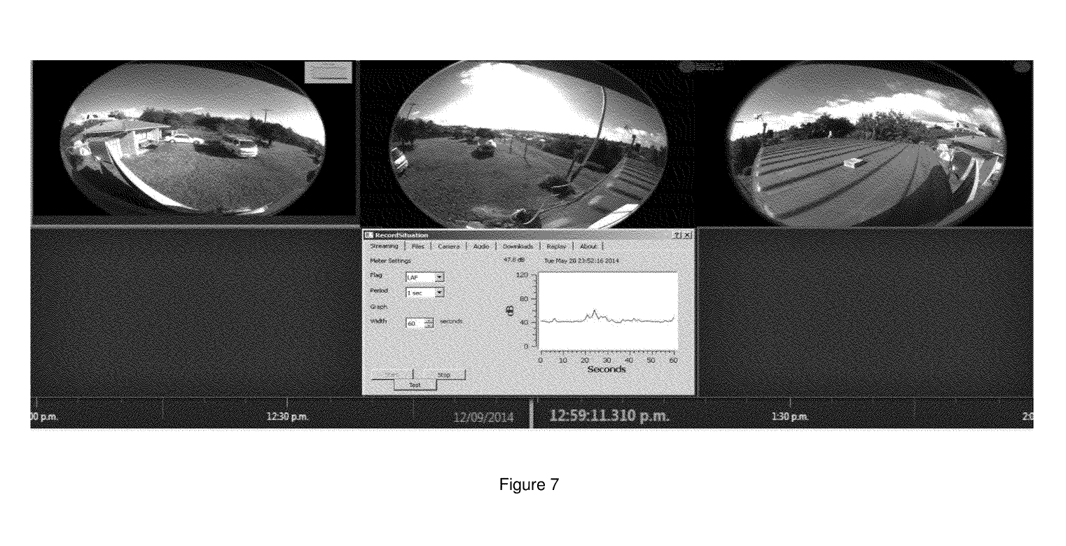

FIG. 7 depicts a screen shot of the multi-feed viewer. One or more feeds are screen shots of one or more camera footage depicting different views of the site under surveillance and a real time sound level versus time plot. Optionally other feeds can also be played, for example a vibration versus time plot and a real time vehicle movement plot.

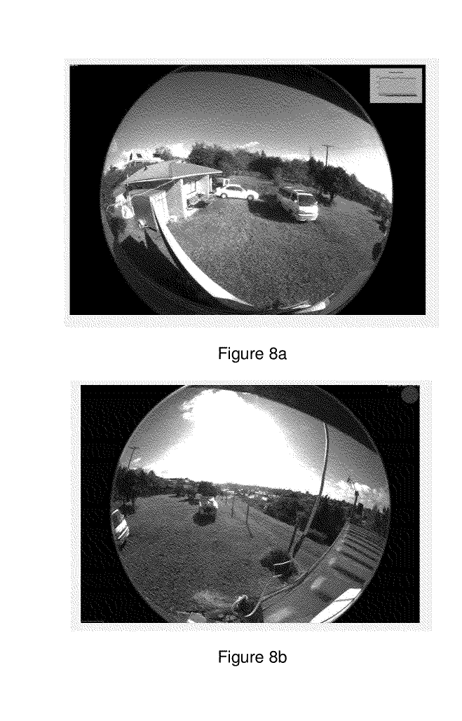

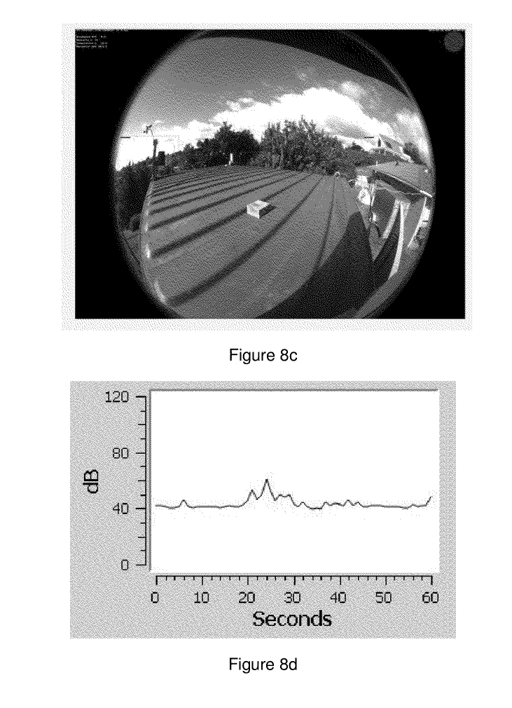

FIGS. 8a-8c depicts snapshots of the camera footage take by three different cameras which may be presented as feeds on the multi-feed viewer.

FIG. 8d depicts snapshot of continuously updating sound level versus time plot which may be presented as another feed on the multi-feed viewer. The graph for vibration level may also be displayed.

It will be seen that the invention provides a number of advantages, especially the ability to provide true situational awareness without involving highly skilled personnel. The invention may also be used to electronically document an environment. Thus it may be used to document an existing environmental situation when a new development is proposed for that existing environment. Thus allows better, more informed, development decisions to be made.

The foregoing description of the invention includes preferred forms thereof. Modifications may be made thereto without departing from the scope of the invention as claimed in appended claim.

What we claim is:

1. An apparatus for monitoring and/or recording noise levels at a location under surveillance over a time period, comprising:
means for capturing visual data of the location under surveillance;
means for capturing audio data at the location under surveillance;
noise level processing means for deriving noise level data at the location under surveillance; and
means to couple the visual and audio data with the noise level data.

2. The apparatus as claimed in claim 1, wherein the means to couple the visual and audio data with the noise level data comprises means for time stamping the data and synchronising the time stamps.

3. The apparatus as claimed in claim 1, wherein one or more visual data of the location along with the audio data are presented simultaneously on a display device with the noise level data portrayed on the display device.

4. The apparatus as claimed in claim 1, wherein the data is provided in a video format whereby it may be presented on a display device, wherein one or more visual data and the noise level data are displayed simultaneously with the audio data being played as sound.

5. The apparatus as claimed in claim 4, wherein the data is processed to provide a file in a multi-feed video type format to be portrayed on a multi-feed viewer presenting visual data, noise level data as one or more feeds.

6. The apparatus as claimed in claim 1, wherein the data is also coupled with further data comprising one or more of: location data; meteorological data; vehicle movement data.

7. The apparatus as claimed in claim 1, wherein the apparatus comprises one or more means for recording the data for a later playback.

8. The apparatus as claimed in claim 1, wherein the noise level data includes sound level and/or vibration level data and is portrayed as a level versus time plot and/or numerically.

9. The apparatus as claimed in claim 1, wherein the apparatus is provided on a portable or mobile apparatus comprising one or more of: vehicle, trolley type device, handheld device.

10. A portable apparatus containing or including a noise level data collection and/or processing system, comprising:
means for capturing audio visual data of a location under surveillance; and
means for deriving noise level data at the location under surveillance.

11. The portable apparatus as claimed in claim 10, wherein the portable apparatus comprises means to couple the visual and audio data with the noise level data.

12. The portable apparatus as claimed in claim 10, wherein the portable apparatus comprises a housing containing the noise level data collection and/or processing system.

13. The portable apparatus as claimed in claim 10, wherein the portable apparatus comprises a vehicle containing or including the noise level data collection and/or processing system.

14. A method of monitoring and/or recording data relating to noise levels at a location under surveillance, the method including:
capturing audio visual data of the location under surveillance;
measuring noise level data at the location under surveillance; and
processing or otherwise coupling the audio visual data with the noise level data so that the audio visual data can be portrayed at a later time together with the measured noise level data, wherein the audio visual data and the noise level data are synchronised.

15. The method as claimed in claim 14, wherein the method includes processing the data to provide a file in a video format which may be played by an audio visual display device with the noise level data portrayed on the display device.

16. The method as claimed in claim 14, wherein the method includes processing the data to provide a file in a video format which may be played by a multi-feed viewer portraying synchronised audio visual data, noise level data.

17. The method as claimed in claim 14, wherein the method further comprises:
coupling or processing the data with further data comprising one or more of: location data; weather data; vehicle movement data; and
presenting the further data with audio visual data and noise level data.

18. The method as claimed in claim 14, wherein the method includes measuring the sound level data and/or vibration level data as an indication of noise level data and processing noise level data to be portrayed numerically or as a level versus time plot.

19. The method as claimed in claim 14, wherein the file may be used for making a determination whether the noise levels are above an acceptable level.

20. The method as claimed in claim 14, wherein the method comprises continuously monitoring the location under surveillance.

21. The method as claimed in claim 14, wherein the file is used for one or more of: evidential purposes, dispute resolution, law enforcement purposes, town planning purposes, environmental mediation, audit purposes.
